(19) United States
(12) Patent Application Publication
(10) Pub. No.: US 2010/0284537 A1
(43) Pub. Date: Nov. 11, 2010

(54) Method for efficiently decoding a number of data channels

(75) Inventor: Guy Inbar, Azur (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/437,295

(22) Filed: May 7, 2009

(51) Int. Cl. H04L 9/06; H04L 9/28

(52) U.S. Cl. 380/277; 380/28

(57) ABSTRACT

The present invention relates to a method for efficiently decoding a plurality of ciphertexts comprising the steps of: (a) receiving at least one cipher key associated with said ciphertexts; (b) expanding said at least one cipher key for producing its corresponding subkeys; (c) storing said subkeys in a memory; (d) loading said subkeys from said memory; and (e) decoding said ciphertexts using said loaded subkeys.

### FIELD OF THE INVENTION

The present invention relates to the field of data decoding. More particularly, the invention relates to a method for efficiently decoding a number of data channels.

### BACKGROUND OF THE INVENTION

As of today, TV channels, or digital media content services, are presently communicated by: land-based radio-type broadcast transmissions, cable network transmissions or space satellite transmissions. In order to limit reception to registered subscribers, it is common practice for content providers to scramble, i,e. encode, their transmissions and to require their registered customers to use a special set-top control box which uses deciphering techniques to decode the received signals. The term of encode refers hereinafter to include scrambling, ciphering or any other process of encrypting data, similarly, the term of decode refers hereinafter to include descrambling, deciphering or any other process of decrypting data.

In order to efficiently encode digital media contents, each media content is divided into data blocks where each block is encoded using a cipher key. After encoding, the encoded media contents are sent to the customers' set-top box. The encoding technique may be a symmetric encoding technique such as the Data Encryption Standard (DES). In symmetric encoding, the cipher key used for encoding data is the same key used for decoding the data. Therefore, the encoded media contents, i.e. the encoded blocks, are typically supplied with their corresponding encoding/decoding cipher key to the customer's set-top box for decoding. Typically, the supplied cipher key itself is also encrypted in order to eliminate content theft. In many cases, the provider of the media contents first encodes the media contents, using one general cipher key, after which he encodes the general cipher key with a customer-specific cipher key for each of his customers. The general cipher key may be decrypted only in the customer's setup box which has a specific decrypting key stored within. Thus the encoded media contents may be broadcasted over open transmission channels, such as stated before, where only the registered customers are able to view the media contents.

It is an object of the present invention to provide a method for efficiently encoding/decoding a number of data blocks.

It is another object of the present invention to provide a reduced hardware system for efficiently encoding/decoding a number of data channels.

Other objects and advantages of the invention will become apparent as the description proceeds.

### SUMMARY OF THE INVENTION

The present invention relates to a method for efficiently decoding a plurality of ciphertexts comprising the steps of: (a) receiving at least one cipher key associated with said ciphertexts; (b) expanding said at least one cipher key for producing its corresponding subkeys; (c) storing said subkeys in a memory; (d) loading said subkeys from said memory; and (e) decoding said ciphertexts using said loaded subkeys.

Preferably, the plurality of ciphertexts is received from different data channels.

The present invention relates to a system for efficiently decoding a plurality of ciphertexts comprising: (a) a processing unit for expanding at least one cipher key into subkeys; (b) memory for storing said subkeys; and (c) a plurality of cipher block decoders which receive said subkeys from said memory and decode said ciphertexts using said subkeys.

In one embodiment, the processing unit is implemented in hardware.

In another embodiment, the processing unit is implemented in software running on a general processing unit.

Preferably, the processing unit is used for encoding and decoding.

In one embodiment, the memory may store keys from different standards.

### BRIEF DESCRIPTION OF THE DRAWINGS

In the drawings:

FIG. 1 is a schematic diagram depicting the operation of a prior art block cipher and key expansion.

FIG. 2 depicts an example of a DES key expansion for producing the corresponding subkeys.

FIG. 3 discloses the table PC-1 and PC-2 of the rearranging order of the cipher key.

FIG. 4 is a schematic diagram depicting the method of the invention according to one embodiment.

### DETAILED DESCRIPTION OF PREFERRED EMBODIMENTS

A block cipher is a symmetric key cipher which operates on fixed-length groups of bits, termed blocks, with an unvarying transformation. When encoding, a block cipher might take, for example, a 128-bit block of plaintext as input, and output a corresponding 128-bit block of ciphertext. The exact transformation is controlled using a cipher key. Prior art block ciphers, which are also referred as substitution-permutation networks, involve a sequential repetition of an internal function called round function. The round function uses in each repetition a derivative of the cipher key known as a subkey for encoding. The basic idea of the round function is to build a complex encoding scheme by composing several simple operations which offer complementary, but individually insufficient, protection. Basic operations include transpositions, translations (e.g., XOR) and linear transformations, arithmetic operations, modular multiplication, and simple substitutions and permutation (non-linear transformations). Decoding is similar to encoding where, in this example; a 128-bit block of ciphertext is decoded using the cipher key, for yielding the original 128-bit block of plaintext. The full description of the encoding and decoding methods can be found in the Federal Information Processing Standards Publication 46-3, Oct. 25, 1999 of the “DATA ENCRYPTION STANDARD” (DES). Other descriptions of the encoding and decoding methods are also present in the Federal Information Processing Standards Publication 197, Nov. 26, 2001 of the “ADVANCED ENCRYPTION STANDARD” (AES), the ISO/IEC standard 9979 (9)—otherwise known as Mulit2, the 4C Entity, LLC. Jan. 17, 2003—C2, X. Lai, J. L. Massey and S. Murphy, Markov ciphers and differential cryptanalysis, Advances in Cryptology—Eurocrypt '91, Springer-Verlag (1992), 17-38—IDEA, and Block encryption algorithm with data-dependent rotations—such as U.S. Pat. No. 5,724,428.

The desirable characteristics for a block cipher include: (a) that each bit of the ciphertext should depend on all bits of the cipher key and all bits of the plaintext, (b) that there should be no statistical relationship evident between the plaintext and the ciphertext, (c) that altering any single plaintext or cipher key bit should alter each ciphertext bit with probability of 0.5, and (d) that altering a ciphertext bit should result in an unpredictable change to the recovered plaintext.

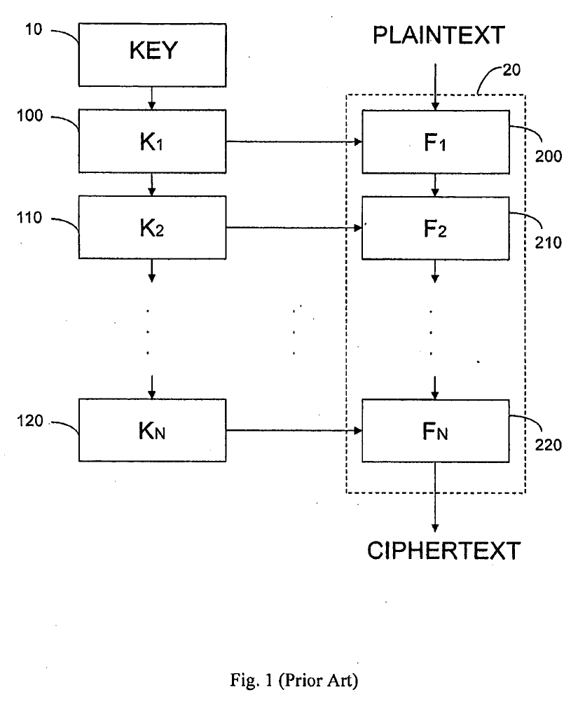

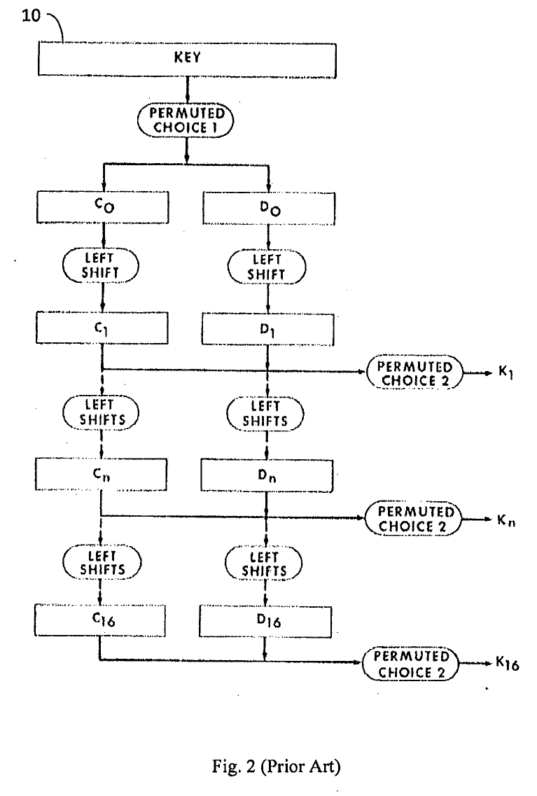

FIG. 1 is a schematic diagram depicting the operation of a prior art block cipher 20 and key expansion. The terms key expansion and key expanding are meant to include hereinafter key schedule, key manipulation, or any other process of deriving a subkey or subkeys from a cipher key. The method of Key expansion will also be discussed in relations to FIG. 2. In prior art systems the key expansion and the block cipher 20 are each performed by dedicated hardware circuits. At first the cipher key 10 is expanded by the key expansion process for producing the first subkey K₁ 100. The subkey K₁ 100 is then fed into round function F₁ 200 for encoding. Thus the key expansion process continues expanding the subkey K₁ 100 for yielding the next subkey K₂ 110, which is fed to the next round of encoding of round function F₂ 210. Thus both processes may continue in parallel; where the key expansion process yields a new subkey each round and the cipher block process continues to encode each round with the round function and the new subkey, until the last key K_{N} 120 is fed into the last round function F_{N} 220 and the round function F_{N} 220 completes the encoding, effectively producing the ciphertext. The decoding process is similar to the described above encoding process, where a ciphertext is received together with the cipher key and the ciphertext is decoded into plaintext using the inverse round functions and the subkeys derived from the expanded received cipher key. Nevertheless, since in the key expansion process each subsequent subkey is based on a former subkey/key, the key expansion circuit can process each subkey only after processing a former subkey/key. Therefore, typically in the prior art systems, there is a dedicated hardware circuit for expanding the cipher key and producing the subsequent subkeys for each round function, although the dedicated key expansion circuit requires much less processing power and time than the circuit processing the round functions.

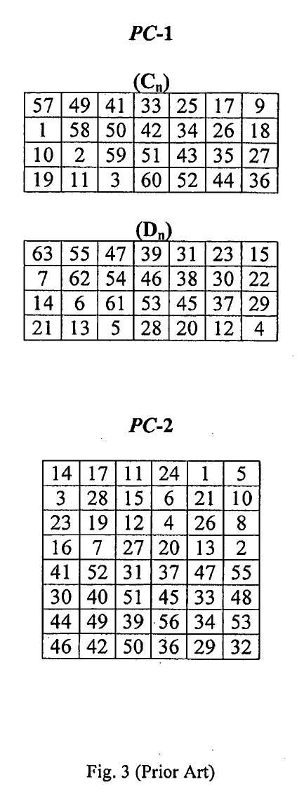

FIG. 2 depicts an example of a DES key expansion for producing the corresponding subkeys. The DES is a block cipher which takes a fixed-length string of plaintext bits and transforms it through a series of complicated operations into a ciphertext string of the same length. In the case of DES, the string length is 64 bits. DES also uses a cipher key to customize the transformation, so that decoding can only be performed by those who know the particular cipher key used to encode. The cipher key ostensibly consists of 64 bits; however, only 56 of these are actually used by the algorithm. Eight bits are used solely for checking parity, and are thereafter discarded. As shown in FIG. 2, the cipher key 10, as may be received with the ciphertext, is first rearranged according to a Permuted Choice table labeled PC-1 shown in FIG. 3. As shown in FIG. 3 the table PC-1 depicts the rearrangement order of the 64 bits in 2 parts Cₙ and Dₙ. The first part is labeled by C₀ and processed apart from the second part labeled D₀. The first part C₀ and the second part D₀ are each left shifted by 1, according to the standard, and may be permuted together according to PC-2 depicted in FIG. 3 for yielding the first subkey K₁. The process may continue with both parts of key as shown in FIG. 2 until all the required subkeys are produced, according to the standard.

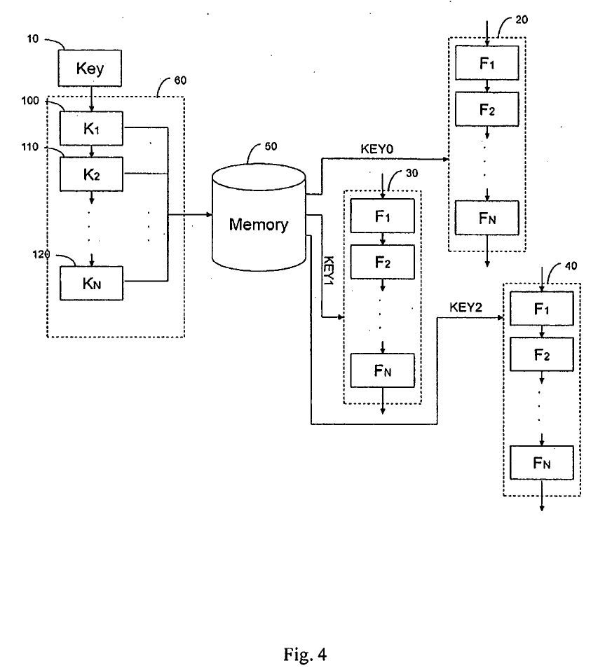

FIG. 4 is a schematic diagram depicting the method of the invention according to one embodiment. At first the cipher key 10 undergoes the key expansion process 60 in order to produce the corresponding subkeys. The key expansion process 60 may be preformed by any processing unit capable of expanding a cipher key according to any one of the cipher block standards, such as DES, AES, multi2, C2, IDEA, etc. The produced subkeys such as subkeys 100, 110, and 120 are stored in memory 50. Memory 50 may be any kind of repository used for storing data such as FLASH, EPROM, RAM, etc. The produced subkeys may then be loaded from memory 50 and used for decoding their corresponding cipher block such as cipher block 20. After the first cipher key 10 has been expanded, the processing unit, used for expanding the key 10, may be used for expanding a new cipher key into a new set of subkeys. The new set of subkeys is also stored in memory 50 from where they may be loaded and used for decoding their corresponding cipher block such as cipher block 30. The processing unit may continue expanding more cipher keys such as the cipher key corresponding to the cipher block 40, in parallel to the continual processing of the other cipher blocks which use the already produced subkeys. In one of the embodiments the processing unit 60 is capable of expanding 4 cipher keys into 4 sets of subkeys in less time than required to decode each of the cipher blocks. In this embodiment only one key expansion processing unit is implemented with 4 dedicated hardware circuits for block ciphering. In other embodiments, processing unit 60 is capable of expanding more (or less) than 4 cipher keys in less time than required to decode each of the cipher blocks. In one of the embodiments the set of subkeys stored in memory 50 which correspond to a certain cipher key may be reloaded and reused for decoding another cipher block having the same corresponding cipher key. In this embodiment each set of subkeys may be stored for a certain amount of time or a certain amount of machine cycles or any other condition before being erased. Thus instead of designing a hardware circuit for manipulating a deciphering key dedicated for each cipher block decoder, one such processing unit may service a plurality, i.e. at least 2, of incoming cipher blocks, effectively saving precious hardware circuit space and time. The encoding process is similar to the described above decoding process, where one processing unit may service a number encoding cipher blocks.

In one of the embodiments the same processing unit and memory may be used for encoding and decoding.

In one of the embodiments the same memory may be used for storing subkeys produced by different standards. The memory may be connected to a plurality of processing units, where each processing unit performs according to one of the standards. For example a memory may be connected to a processing unit, which expands keys according to the DES standard, and to a processing unit which expands keys according to the AES standard.

In one of the embodiments the key expansion processing unit is implemented in hardware. In one embodiment the key expansion processing unit is implemented in a time relaxed hardware design as opposed to the time strict hardware design of the hardware circuits decoding the cipher blocks. In another embodiment the key expansion processing unit may be implemented in software processed by a general processing unit.

In one of the embodiments the key expansion processing unit and a number of cipher block decoders are implemented together, where each cipher block decoder decodes an incoming data channel in a continual manner, cipher block after cipher block, and the key expansion processing unit services all the cipher blocks decoders in turns. In one of the embodiments the data channels are media channels.

For the sake of brevity an example is set forth for depicting the process of a key expansion processing unit according to an embodiment of the invention. In this example many media channels are received in parallel. If 1 full HD channel is transmitted at a rate of 8 MB/s video together with two audio channels each 384 KB/s and additional information, then the total data rate can be assumed at around 9 MB/s. An AES decoder can decode 128 bits in a cipher block, meaning that 74K AES cipher blocks are required to be processed each second in order to decode one channel (9M/128=9*2²⁰/2⁷=9*2¹³˜74K AES cipher blocks per second). If for example each AES cipher block round requires 500 machine cycles, then the total machine cycles required for decoding one full HD channel is 37M machine cycles per second. Since the cipher blocks are required to be encoded in tandem, in order to decode 1 HD channel without causing delays requires the cipher block decoders to process in a rate at least 40 MHz. In this example the key expansion circuit requires an estimated 4K machine cycles for expanding one cipher key into a set of subkeys. Thus the key expansion processing unit may expand one key in a 0.0001 sec, in a 40 MHz rate, effectively allowing the key expansion processing unit to expand many keys for many AES cipher blocks. Since several blocks share the same key, it is apparent that even if multiple AES cipher block decoders are required in order to support this scenario of receiving and displaying multiple HD channels only one key expansion engine is required, which can service these AES cipher block decoders.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for efficiently decoding a plurality of ciphertexts comprising the steps of:
a. receiving at least one cipher key associated with said ciphertexts;
b. expanding said at least one cipher key for producing its corresponding subkeys;
c. storing said subkeys in a memory;
d. loading said subkeys from said memory; and
e. decoding said ciphertexts using said loaded subkeys.

2. A method according to claim 1, where the plurality of ciphertexts is received from different data channels.

3. A system for efficiently decoding a plurality of ciphertexts comprising:
a. a processing unit for expanding at least one cipher key into subkeys;
b. memory for storing said subkeys; and
c. a plurality of cipher block decoders which receive said subkeys from said memory and decode said ciphertexts using said subkeys.

4. A method according to claim 3, where the processing unit is implemented in hardware.

5. A method according to claim 3, where the processing unit is implemented in software running on a general processing unit.

6. A method according to claim 3, where the processing unit is used for encoding and decoding.

7. A method according to claim 3, where the memory may store keys from different standards.
